(19) United States
(12) Patent Application Publication
(10) Pub. No.: US 2017/0177029 A1
(43) Pub. Date: Jun. 22, 2017

(54) PORTABLE COMPUTING DEVICE ACCESS

(71) Applicant: HEWLETT-PACKARD DEVELOPMENT COMPANY, L.P., HOUSTON, TX (US)

(72) Inventors: MICHAEL NGUYEN, HOUSTON, TX (US); BINH T TRUONG, HOUSTON, TX (US); MANNY NOVOA, HOUSTON, TX (US); CHI SO, HOUSTON, TX (US)

(21) Appl. No.: 15/306,102

(22) PCT Filed: Sep. 13, 2014
(86) PCT No.: PCT/US2014/055536

§ 371 Date: Oct. 23, 2016

(51) Int. Cl. G06F 1/16; H04L 29/06; G06F 21/62; G06F 21/44; G06F 21/30

(52) U.S. Cl. CPC G06F 1/1632; G06F 21/445; G06F 21/305; G06F 21/6218; H04L 63/083; G06F 1/1613; G06F 2221/21

(57) ABSTRACT

According to an example of providing access to a portable computing device, a connection is established with a docking station. A request from the docking station to perform an action related to a portable computing device is received, and a rule associated with the portable computing device from a policy database is fetched. A determination is made whether to perform the action, and in the event that an action is to be performed, an instruction is transmitted to perform the action on the docking station.

### BACKGROUND

Portable or mobile computing systems, devices, and electronic components in general may be sold or configured to work with a docking station or other component adapted to receive the portable device. Such devices may require hardware or software security mechanisms to prevent unauthorized access, theft, or other unintended consequences.

### BRIEF DESCRIPTION OF THE DRAWINGS

FIG. 1 illustrates a flowchart of transmitting an instruction to a docking station, according to an example of the present disclosure;

FIG. 2 illustrates a flowchart of receiving an instruction from a remote server, according to an example of the present disclosure;

FIG. 3 illustrates a first view of a docking station for receiving an instruction from a remote server, according to an example of the present disclosure;

FIG. 4 illustrates a second view of a docking station for receiving an instruction from a remote server, according to an example of the present disclosure;

FIG. 5 illustrates a schematic representation of a computing device that may be used as a platform for implementing or executing at least one of the processes depicted in FIGS. 1-2 according to an example of the present disclosure.

### DETAILED DESCRIPTION

Computing systems, devices, and components such as laptop computers, thin clients, tablets, smartphones, handheld scanners, retail point of sale devices, and other computing equipment (hereinafter “device” or “devices”) may be portable or mobile, such that the devices can be used in environments where portability is required.

While convenient, such devices may introduce concerns related to theft of the portable hardware, or unpermitted access to the hardware and/or software running on the devices. Such access may have wide-ranging effects including financial loss, loss of productivity, data and identity theft, industrial espionage, audit failures, and other negative consequences.

In some cases, docking stations and/or physical security measures such as locks, keys, and/or cables may be employed to permit or restrict access to a device. However, such measures may result in the need to manage a number of keys for a number of users, especially in a corporate environment, requiring significant overhead. At times, authorized users may be unable to access a device due to a lost key, a broken lock, or an inability to locate an administrator charged with providing access to the device.

Moreover, such measures do not allow for management of access to, for example, input/output (“IO”) ports on a device, such as USB or Firewire ports. Such measures also do not allow for advanced authentication features, such as biometrics or two-factor authentication. Finally, such measures often require the installation of hardware mechanisms such as locks or cables that detract from the appearance of a docking station and/or device.

According to an example of providing access to a portable computing device, a connection is established with a docking station. A request from the docking station to perform an action related to a portable computing device is received, and a rule associated with the portable computing device from a policy database is fetched. A determination is made whether to perform the action, and in the event that an action is to be performed, an instruction is transmitted to perform the action on the docking station.

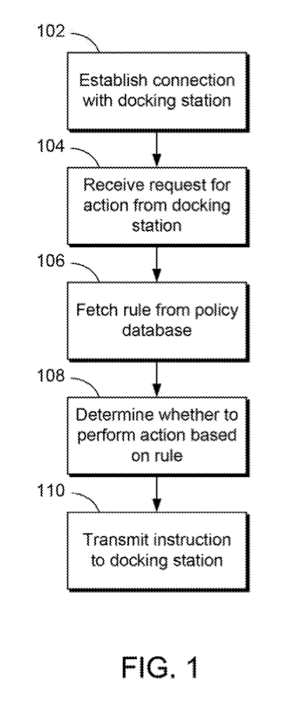

FIG. 1 illustrates a flowchart of transmitting an instruction to a docking station, according to an example of the present disclosure. In an example, a system executing the steps of FIG. 1 may be a cloud-based computing system, with cloud-connected or network-connected servers, or other local or remote computing devices to communicate with a docking station paired with a device.

In an example, in block 102, a connection is established with a docking station. The docking station may be, e.g., a receiving device configured to receive a device, such as a laptop, tablet, or other devices described above. In some examples, a connection may also be established directly with a device paired or mated with a docking station, or with both the docking station and the device.

In block 104, a request for an action is received from the docking station or, in some examples, directly from the device. A requested action may be, for example, to unlock the device from the docking station through remote activation of a physical lock; to unlock the device from the docking station through remote activation of a digital or software lock; to allow access to an input/output (“I/O”) port on the device; or to launch or trigger an application protocol interface (“API”) on the device, or receive input from the API.

In block 106, a rule is fetched from a policy database. The rule may relate to time, the user, groups, the device, the docking station, or some other parameter used to determine whether the action requested in block 104 should be executed. For example, a rule may indicate that a docking station should unlock a physical lock on a docking station to permit removal of a device from the docking station between the hours of 9 AM and 5 PM. In another example, the rule may indicate that access to the USB port on a device or docking station may only be allowed when the device is coupled to the docking station, and only if accessed by a user associated with an administrator group. In other examples, particular users may be restricted from accessing certain devices or docking stations. In yet other examples, the rules may further comprise restrictions, such as bandwidth or traffic restrictions.

In block 108, a determination is made whether to perform the requested action based on the rule. The determination may be based on the processing of a single rule, multiple rules, or combinations of rules using, e.g., Boolean operators.

In block 110, an Instruction is transmitted to the docking station or, in some examples, directly to a device or to both the device and docking station. For example, the instruction may be to unlock a physical lock, using a motor or solenoid, on the docking station, or to permit I/O access. In some examples, the instruction may also include an Instruction to “autolock” a device, e.g., to lock the physical lock or port access after a pre-set interval of use or inactivity.

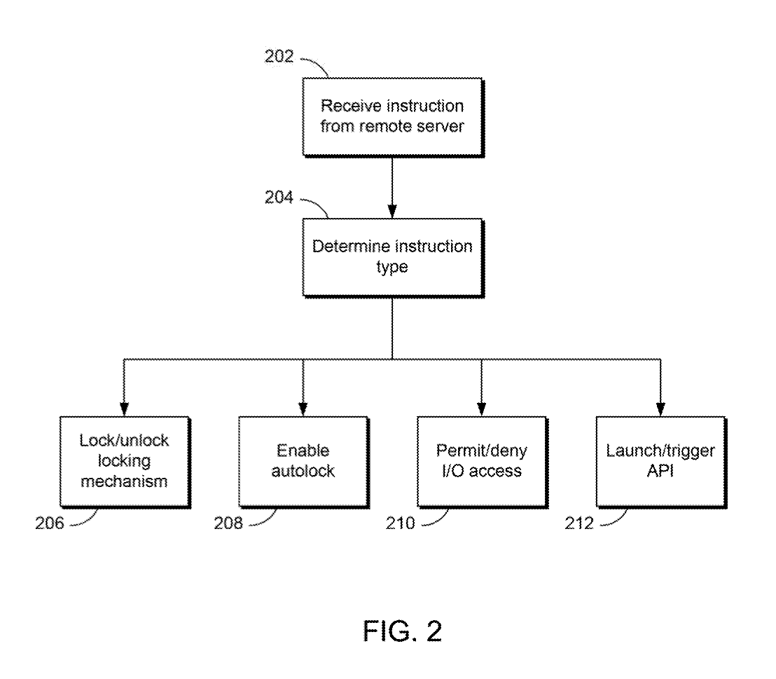

FIG. 2 illustrates a flowchart of receiving an instruction from a remote server, according to an example of the present disclosure. The steps of FIG. 2 may be carried out, for example, by a device that can be mated or paired with a docking station.

In block 202, in an example, an instruction is received from a remote server, e.g., the cloud server discussed with respect to FIG. 1. In block 204, the Instruction type is determined.

In block 206, if the instruction type is to lock or unlock a physical or mechanical lock, e.g., using a solenoid, the lock is locked or unlocked. For example, the docking station may receive a digital instruction to unlock a device from the docking station, and trigger the solenoid to release a mechanical lock.

In block 208, if the instruction type is to enable an autolock, the autolock feature on the docking station and/or device is enabled. As discussed above, the autolock feature may comprise a timer or countdown, or monitor for a period of inactivity.

In block 210, if the instruction type is to permit or deny access to an I/O port, the access is permitted or denied on the docking station or device. For example, block 210 may permit access to a USB port on a device, but deny access to a Firewire port. In some examples, block 210 may also permit only certain types of traffic over a port, or may throttle the amount of data transmitted over a port based on a rule.

In block 212, if the instruction type is to launch or trigger an application programming interface (“API”), the docking station may instruct the device to launch an API, or the device may receive the Instruction directly. In some examples, the API may be a software tool requesting a password on the device, or other type of authentication such as biometric authentication or a text message code validation routine. The results of block 212 may be transmitted back to a remote server for further processing, e.g., through the steps of FIG. 1.

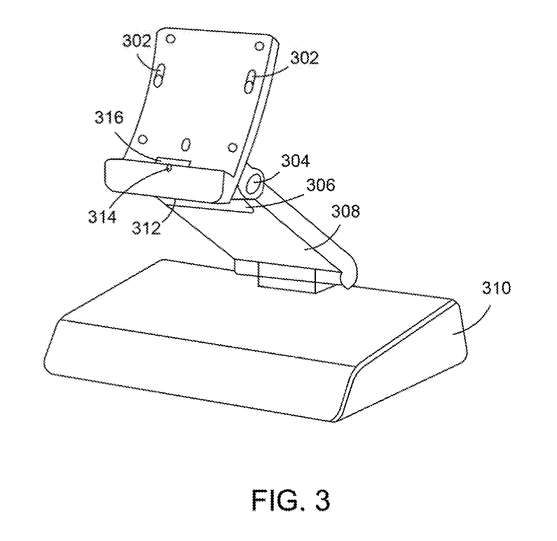

The requests for actions and instructions received and transmitted in FIGS. 2 and 3 may be logged or otherwise stored on, e.g., the remote server, the docking station, or the device itself for review, auditing, analytics, and other usage.

FIG. 3 illustrates a first view of a docking station for receiving an instruction from a remote server, according to an example of the present disclosure. In an example, docking station 300 comprises docking hooks and/or guide posts 302, or in some examples an adapter, to receive a device such as a laptop, tablet or other devices, including those discussed above.

In some examples, docking station 300 may comprise a key lock 304 which may be disabled or overridden, or which may serve as a backup in case access to a remote server, as discussed above, is not available. Arm release lever 306, or other release mechanism, may be utilized to release or remove a device from the docking station 300.

An arm 308 may connect the docking area to a base 310. In some examples, the arm 308 may comprise multiple hinges to allow flexibility of the docking station. Docking station 300 may also comprise an eject switch 312, a charging LED 314, and a docking connector 316.

Docking station 300 may also comprise a hardware switch controller, including one or more chipsets. The hardware switch controller may be coupled to a physical locking mechanism, which may include an electronic solenoid and a power source.

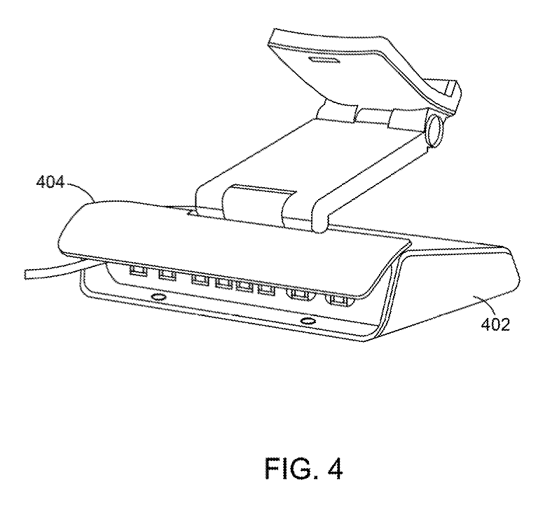

FIG. 4 illustrates a second view of a docking station for receiving an instruction from a remote server. Panel 404 on base 402 may comprise one or more I/O ports, such as USB, Firewire, HDMI, DisplayPort, or other video connector. Panel 404 may also comprise a network connection or network adapter, such as for receiving an Ethernet cable. In some examples, docking station 400 comprises a wireless network adapter (not shown).

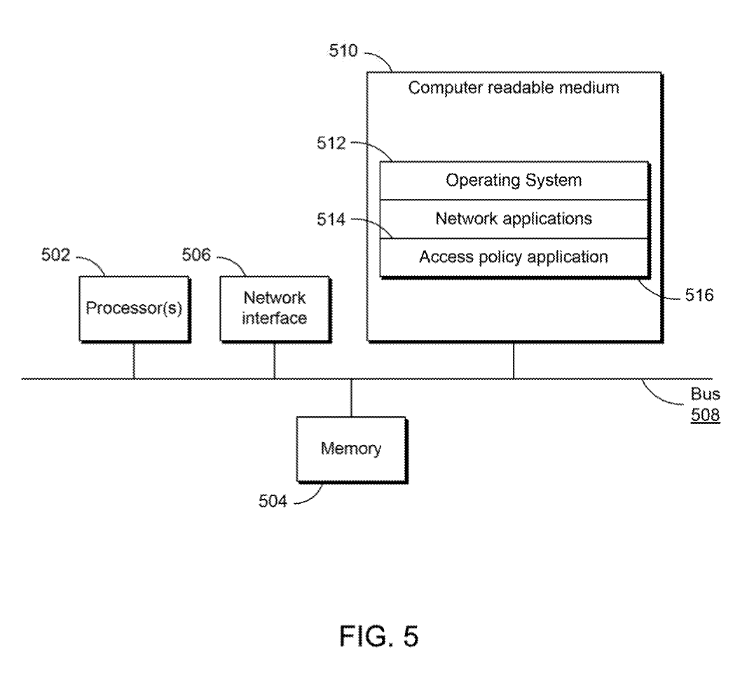

FIG. 5 illustrates a schematic representation of a computing device that may be used as a platform for implementing or executing at least one of the processes depicted in FIGS. 1-2 according to an example of the present disclosure.

In an example, device 500 comprises a processor or CPU 502, memory 504, network interface 506, and a computer readable medium 510. The processor 502, memory 504, network interface 506, and computer readable medium 510 may be coupled by a bus or other interconnect. In some examples, computer readable medium 510 may comprise an operating system 512, network applications 514, and/or a policy access application 516 for receiving or transmitting instructions and/or processing rules related to access to a device. Device 500 may also comprise an embedded controller.

Some or all of the operations set forth in the figures may be contained as a utility, program, or subprogram In any desired computer readable storage medium, or embedded on hardware. In addition, the operations may be embodied by machine-readable instructions. For example, they may exist as machine-readable instructions in source code, object code, executable code, or other formats. The computer readable medium may also store other machine-readable instructions, including instructions downloaded from a network or the Internet.

The computer-readable medium may also store a firmware that may perform basic tasks such as recognizing input from input devices, such as a keyboard or a keypad; sending output to a display; keeping track of files and directories on a computer readable medium; controlling peripheral devices, such as drives, printers, or image capture devices; and managing traffic on a bus. The network applications may include various components for establishing and maintaining network connections, such as machine readable instructions for implementing communication protocols including but not limited to TCP/IP, HTTP, HTTPS, Ethernet, USB, and FireWire.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A method of providing access to a portable computing device, comprising:
establishing a connection with a docking station;
receiving a request from the docking station to perform an action related to a portable computing device;
fetching a rule associated with the portable computing device from a policy database;
determining whether to perform the action based on the rule; and
in the event that the action is to be performed, transmitting an instruction to perform the action to the docking station.

2. The method according to claim 1, wherein the rule comprises triggering a locking mechanism.

3. The method according to claim 2, wherein the locking mechanism is a solenoid.

4. The method according to claim 1, wherein the rule comprises triggering an autolock.

5. The method according to claim 1, wherein the rule comprises permitting I/O access.

6. The method according to claim 1, wherein the rule comprises launching an application protocol interface.

7. The method according to claim 1, wherein the policy database is stored at a network location.

8. The method according to claim 1, wherein transmitting an instruction to perform the action to the docking station comprises transmitting the instruction through the device.

9. A docking station comprising:
an embedded controller to receive an instruction from a remote server based on a policy database rule; and
an adapter to receive a portable computing device, wherein
the embedded controller is to determine an instruction type received from the remote server and execute an action on the docking station to control access to the portable computing device based on the instruction.

10. The docking station according to claim 9, further comprising an input/output port.

11. The docking station according to claim 9, further comprising an electronic lock motor.

12. The docking station according to claim 9, further comprising a mechanical latch.

13. A non-transitory computer readable storage medium on which is embedded a computer program, said computer program to provide an instruction to access a portable computing device, said computer program comprising a set of instructions to:
establish a connection with a docking station;
receive a request from a portable computing device to unlock a locking mechanism associated with the portable computing device;
fetch a rule associated with the docking station from a policy database;
determine whether to unlock the locking mechanism based on the rule; and
in the event that the locking mechanism is to be unlocked, transmitting an instruction to unlock the locking mechanism.

14. The non-transitory computer readable storage medium of claim 13, wherein the rule associated with the docking station is time-based.

15. The non-transitory computer readable storage medium of claim 13, wherein the rule associated with the docking station is user-based.
